(19) United States
(12) Patent Application Publication
(10) Pub. No.: US 2009/0303483 A1
(43) Pub. Date: Dec. 10, 2009

(54) EXPOSURE APPARATUS AND DEVICE MANUFACTURING METHOD

(75) Inventor: Osamu Morimoto, Utsunomiya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/469,096

(22) Filed: May 20, 2009

(30) Foreign Application Priority Data
Jun. 10, 2008 (JP) 2008-152257

(51) Int. Cl. G01B 11/00; G03B 27/42

(52) U.S. Cl. 356/401; 355/53

(57) ABSTRACT

An exposure apparatus which aligns an original held by an original stage with a substrate held by a substrate stage, includes a measurement unit which measures the positional relationship between a mark of the original and a mark of the substrate stage, and a control unit which controls the measurement unit to execute the measurement by bringing the mark of the original and the mark of the substrate into the field of the measurement scope. The control unit controls the measurement unit to execute the measurement in accordance with a first procedure or a second procedure (in the first procedure, the mark attached on the original is measured by the measurement unit a number of times smaller than that in the second procedure), thereby performing the alignment in accordance with the results obtained by the executed measurement.

### BACKGROUND OF THE INVENTION

1. Field of the Invention

The present invention relates to an exposure apparatus which aligns a plurality of objects with each other, and a device manufacturing method.

2. Description of the Related Art

Along with miniaturization of circuit patterns, a semiconductor device manufacturing exposure apparatus is required to align an electronic circuit pattern formed on an original (to be referred to as a reticle hereinafter) and a pattern on a substrate (to be referred to as a wafer hereinafter) with high accuracy.

In recent years, to improve the processing speed in an exposure process, an exposure apparatus including a plurality of wafer stages for holding and moving a wafer has been proposed. For example, an exposure apparatus including two wafer stages is provided with a measurement area for measuring a wafer alignment error and focus information, and an exposure area for transferring the pattern of a reticle onto the wafer based on the measurement result obtained in the measurement area. Each wafer stage reciprocates between these two areas in the apparatus in accordance with the sequence of an exposure process.

Each area is provided with an interferometer for measuring the position of the wafer stage. Each interferometer measures the position of the wafer stage in each area. Every time the wafer stages are swapped between these areas, the information of the measurement target stage must be switched in each area. This is because the measurement of the position of the wafer stage by the interferometer is intended not to guarantee an absolute position but to measure a change in position. For this reason, when the wafer stage moves from the measurement area to the exposure area, and the interferometer used is switched, the wafer stage naturally suffers a position error albeit very small.

TTR (Through The Reticle) measurement, for example, is used in measuring a wafer stage position error generated upon switching the used interferometer. In the TTR measurement, a position shift between a mark attached on the reticle and a wafer stage reference mark attached on the wafer stage is detected directly through the exposure lens (Japanese Patent Laid-Open Nos. 2005-175400 and 05-045889). More specifically, a relative error between a reticle deformation error and placement error and a wafer stage position error is measured by bringing a mark attached on the reticle and a wafer stage reference mark attached on the wafer stage into the field of a measurement device, and aligning these marks. This measurement method can also be used to measure error components generated as the aberration of the projection optical system fluctuates due to exposure heat or factors associated with the apparatus internal atmosphere.

In this manner, the exposure apparatus performs an arithmetic correction operation for position errors of the reticle, wafer, stages, and projection optical system to calculate the precise positions of the exposure shots. Then, the exposure apparatus exposes each shot step by step while driving the reticle stage and the wafer stage by the step & scan scheme and correcting the imaging characteristics of the projection optical system as well.

At the time of measurement for correcting a wafer stage position error and the like generated upon switching the interferometer used, to calculate a reticle deformation error and placement error and a wafer stage position error, a need arises for measuring shift amounts of a plurality of marks attached on the upper and lower portions on the reticle.

For example, assume that mark groups XU and XD which can be used to measure a shift in the X direction, and mark groups YU and YD which can be used to measure a shift in the Y direction are arranged on the upper and lower portions on a reticle, as shown in FIG. 7. In this case, the use of the measurement device disclosed in the above-described prior art allows simultaneous measurement of the mark groups YU and XU juxtaposed on a line in the longitudinal direction of the exposure slit. This similarly allows simultaneous measurement of the mark groups YD and XD. However, the reticle stage must be driven in measuring both mark groups separated in the upper and lower portions on the reticle (e.g., the mark groups XU and XD).

Since a relative rotation error between the wafer stage and the reticle (a wafer stage position error) is calculated based on the difference between the shift amounts of the marks YUL and YUR, this calculation requires measurement of the mark group YU (or the mark group YD) alone. On the other hand, since a relative rotation error between the reticle and the reticle stage (a reticle placement error) is calculated based on the difference between the distances of the upper and lower X marks from the track of the reticle stage in the Y direction, this calculation requires measurement of both the mark groups XU and XD (see FIG. 8). Note that FIG. 8 illustrates only the marks XUR and XDR for the sake of simplicity.

Also, when the reticle has physically expanded upon being subjected to an exposure load, a need arises for measuring an error attributed to the expansion. Since a reticle expansion error (reticle deformation error) in the X direction is calculated based on the difference between the shift amounts of the marks XUL and XUR, this calculation requires measurement of the mark group XU (or the mark group XD) alone. On the other hand, since a reticle expansion error (reticle deformation error) in the Y direction is calculated by measuring the difference between the Y shift amounts between the upper and lower Y marks, this calculation requires measurement of both the mark groups YU and YD.

In this manner, the measurement of an error generated due to reticle deformation or misplacement often requires the measurement of mark groups which cannot be measured simultaneously. Even if measurement is done at a speed of several tens of milliseconds to several hundreds of milliseconds per mark using a measurement device which allows high-speed processing, the throughput in wafer processing inevitably decreases.

### SUMMARY OF THE INVENTION

The present invention provides an exposure apparatus which changes a procedure for use in alignment measurement between a reticle and a wafer (wafer stage) according to the circumstances involved, and a device manufacturing method.

According to a first aspect of the present invention, there is provided an exposure apparatus which aligns an original held by an original stage with a substrate held by a substrate stage, and projects a pattern of the original onto the substrate to expose the substrate, the apparatus comprising: a measurement unit configured to measure a positional relationship between a mark attached on the original and a mark attached on the substrate stage; and a control unit configured to control the measurement unit to execute the measurement by bringing the mark attached on the original and the mark attached on the substrate into a field of the measurement scope, wherein the control unit is configured to control the measurement unit to execute the measurement in accordance with a first procedure in the alignment when original replacement has not taken place in a sequence of an exposure process, and control the measurement unit to execute the measurement in accordance with a second procedure in the alignment immediately after original replacement has taken place in a sequence of an exposure process, thereby performing the alignment in accordance with the results obtained by the executed measurement, and in the first procedure, the mark attached on the original is measured by the measurement unit a number of times smaller than a number of times of measurement in the second procedure.

According to a second aspect of the present invention, there is provided a device manufacturing method comprising: exposing a substrate by an exposure apparatus; and developing the substrate, wherein the exposure apparatus which aligns an original held by an original stage with a substrate held by a substrate stage, and projects a pattern of the original onto the substrate to expose the substrate, includes a measurement unit configured to measure a positional relationship between a mark attached on the original and a mark attached on the substrate stage; and a control unit configured to control the measurement unit to execute the measurement by bringing the mark attached on the original and the mark attached on the substrate into a field of the measurement scope, wherein the control unit is configured to control the measurement unit to execute the measurement in accordance with a first procedure in the alignment when original replacement has not taken place in a sequence of an exposure process, and control the measurement unit to execute the measurement in accordance with a second procedure in the alignment immediately after original replacement has taken place in a sequence of an exposure process, thereby performing the alignment in accordance with the results obtained by the executed measurement, and in the first procedure, the mark attached on the original is measured by the measurement unit a number of times smaller than a number of times of measurement in the second procedure.

Further features of the present invention will become apparent from the following description of exemplary embodiments with reference to the attached drawings.

### BRIEF DESCRIPTION OF THE DRAWINGS

FIG. 1 is a top view illustrating an example of the arrangement of an exposure apparatus according to the first embodiment;

FIG. 2 is a side view illustrating the example of the arrangement of the exposure apparatus according to the first embodiment;

FIG. 3 is a flowchart illustrating an example of the overall sequence of a process in the exposure apparatus shown in FIGS. 1 and 2;

FIG. 4 is a flowchart illustrating an example of the sequence of a process in step S106 of FIG. 3;

FIG. 5 is a flowchart illustrating an example of the sequence of a process in an exposure apparatus according to the second embodiment;

FIG. 6 is a flowchart illustrating an example of the sequence of a process in an exposure apparatus according to the third embodiment;

FIG. 7 is a view illustrating an example of the arrangement of marks on a reticle; and

FIG. 8 is a view for explaining an example of a method of measuring a relative reticle rotation error.

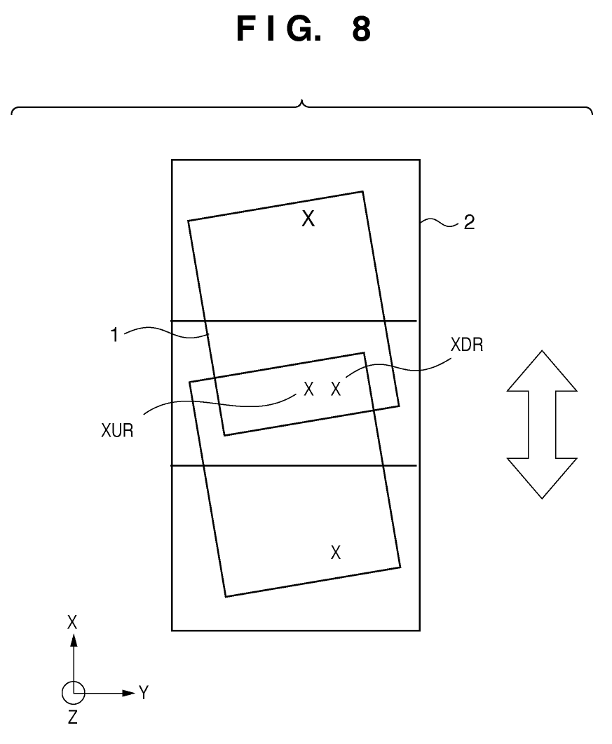

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

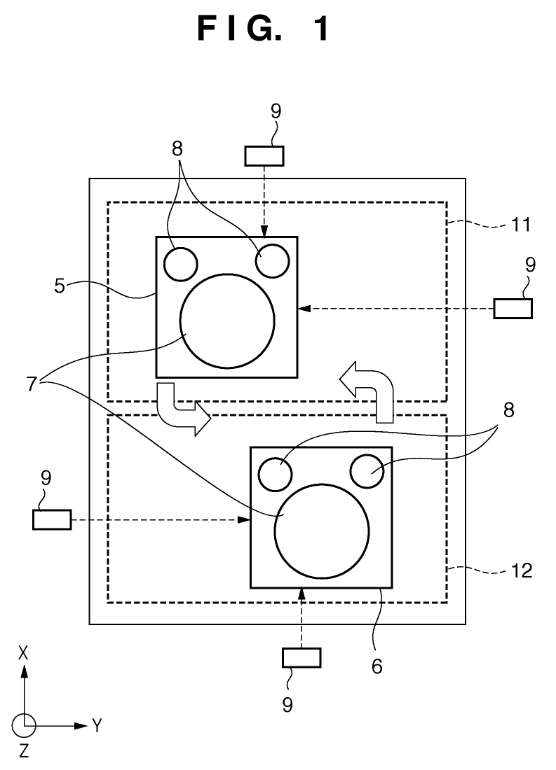

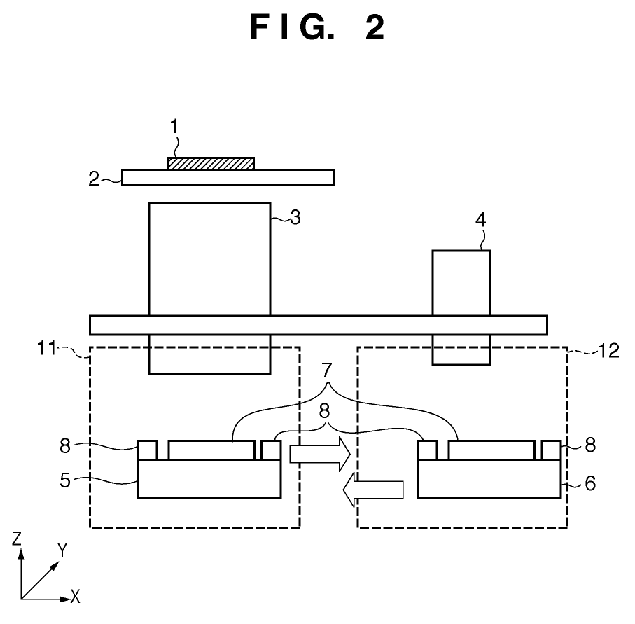

FIGS. 1 and 2 are views illustrating an example of the arrangement of an exposure apparatus according to one embodiment of the present invention. FIG. 1 is a top view of the apparatus when viewed from above, and FIG. 2 is a side view of the apparatus when viewed sideways. Note that the exposure apparatus shown in FIGS. 1 and 2 includes a plurality of (in this case, two) wafer stages.

Referring to FIGS. 1 and 2, reference numeral 1 denotes a reticle (mask) serving as an original; 2, a reticle stage (original stage) which moves the reticle 1 while holding it; and 5 and 6, wafer stages (substrate stages) which move a wafer 7 serving as a substrate to an arbitrary position while holding it.

Reference numerals 9 denote laser interferometers, which precisely control the positions of the wafer stages 5 and 6. A wafer 7 is transported from outside the apparatus by a wafer transport means (not shown), and held by the wafer stage 5 or 6. The wafer stages 5 and 6 reciprocate between two areas (first and second areas) in the apparatus in accordance with the sequence of an exposure process.

The first area is a region (a region surrounded by a broken line 12 in FIGS. 1 and 2) for measuring an alignment error of the wafer 7 and focus information. The first area will be referred to as the “measurement area” hereinafter. Also, the second area is a region (a region surrounded by a broken line 11 in FIGS. 1 and 2) for transferring the pattern of the reticle 1 onto the wafer 7 via a projection optical system 3 based on the information of the wafer 7 measured in the measurement area 12. The second area will be referred to as the “exposure area” hereinafter.

In the measurement area 12, shift and deformation information of the wafer 7 in the two-dimensional direction and vertical direction are measured using a wafer alignment scope 4. The wafer alignment scope 4 serves as a measurement unit having the functions of a microscope for measuring the pattern on the wafer and measuring a shift of the wafer in the X and Y directions, and a leveling measurement device for detecting the level information at each point on the wafer. Shift and deformation information of the wafer 7 are measured in the measurement area 12 while the wafer 7 undergoes an exposure process in the exposure area 11. Hence, the use of an exposure apparatus including a plurality of wafer stages improves both the processing speed and the accuracy as compared with that including a single wafer stage.

The laser interferometers 9 measure the positions of the wafer stages 5 and 6. Every time the two wafer stages are swapped between the movement areas, the information of the measurement target stage must be switched in each area. This is because the interferometer 9 is used not to guarantee an absolute position but to measure a change in position, as described above. For this reason, when the wafer stage 5 or 6 moves from the measurement area 12 to the exposure area 11, and the interferometer 9 used is switched, the wafer stage 5 or 6 naturally suffers a position error albeit very small. An error of the position (including the orientation) of each of the wafer stages 5 and 6 generated upon switching the laser interferometer 9 used is considered to include error components attributed to, for example, a shift in the two-dimensional direction, the level, the rotation, and the tilt. Since the exposure apparatus must align the reticle 1 and the wafer 7 with high accuracy, it is necessary to measure and correct these stage error components albeit very small. For example, one known method detects the pieces of position information of mark patterns on glass substrates rigidly fixed on the wafer stages 5 and 6, and measures position errors of the wafer stages 5 and 6. Referring to FIGS. 1 and 2, glass substrates called wafer stage reference marks (to be simply referred to as stage reference marks hereinafter) 8 are provided on each of the wafer stages 5 and 6. A stage position error is measured and corrected in the measurement area 12 by detecting the patterns on the stage reference marks 8 using the wafer alignment scope 4.

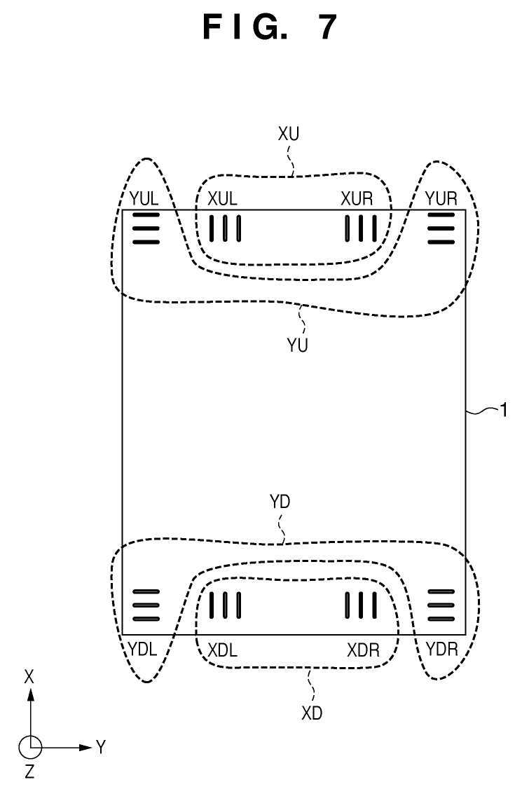

To measure shifts of the wafer stages 5 and 6, one set of mark groups XU/YU or XD/YD as shown in FIG. 7 alone need only be measured, and therefore the reticle stage 2 need not be driven. On the other hand, to measure a deformation error and placement error of the reticle 1, marks XU, YU, XD, and YD as described above need to be measured, and therefore the reticle stage 2 needs to be driven. Note that a placement error of the reticle 1 occurs upon reticle replacement, and changes in only negligibly small amounts thereafter. When a large number of wafer groups are processed per reticle, reticle replacement takes place only at the start of processing of a new lot, and does not take place during the processing of the lot. From these processing features, in this embodiment, a reticle placement error is measured only when reticle replacement has taken place at the start of processing of a new lot. That is, both sets of the mark groups XU/YU and XD/YD are measured at the start of processing of a new lot, and one set of the mark groups XU/YU or XD/YD alone is measured thereafter in order to correct only a shift of the wafer stage during the processing of the lot using the same reticle. This makes it possible to reduce the number of times of reticle mark measurement in processing the second and subsequent wafers in the lot. Moreover, because a reticle placement error is corrected at the start of processing of a new lot, the error never adversely affects the exposure process.

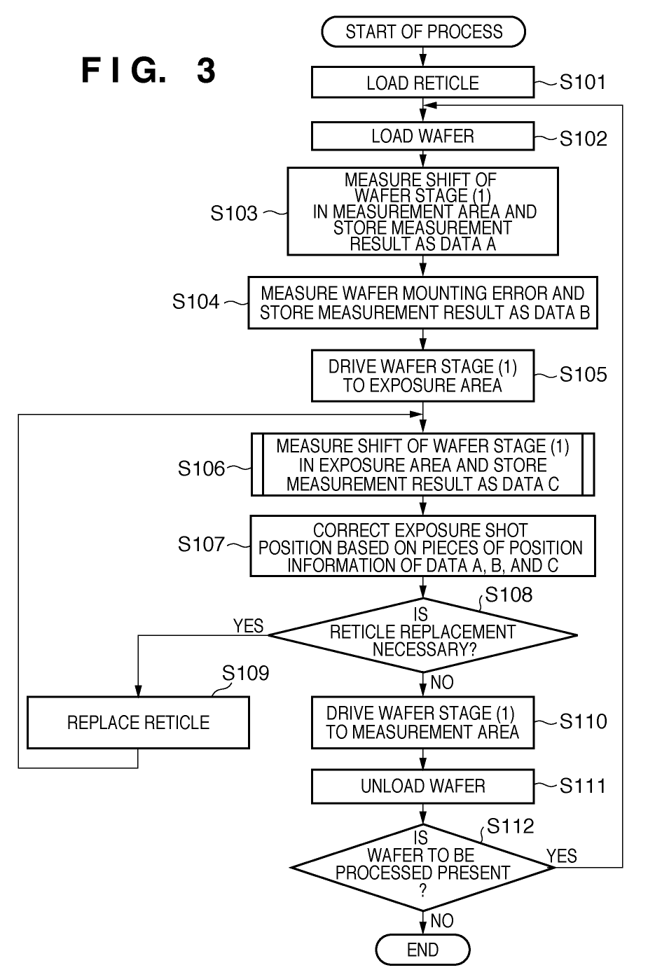

The sequence of an exposure process in the exposure apparatus shown in FIGS. 1 and 2 will be explained below with reference to FIG. 3. The following explanation will be given by attaching importance to a process of correcting a stage error generated upon switching the interferometer used, and aligning the reticle and the wafer. For the sake of descriptive convenience, the process is assumed to start while wafer stage (1) such as that denoted by reference numeral 5 in FIGS. 1 and 2 is present in the measurement area 12, and a description of wafer stage (2) such as that denoted by reference numeral 6 in FIGS. 1 and 2 will not be given. As long as wafer stages (1) and (2) can be independently, parallelly operated, and processing on wafer stage (1) is in progress in the measurement area 12, processing on wafer stage (2) is also in progress in the exposure area 11 as in wafer stage (1).

First, a control unit (e.g., an apparatus control computer (not shown)) in the exposure apparatus controls a reticle transport means (not shown) to load a reticle 1 onto the reticle stage 2 (step S101). The reticle transport means has a mechanical error, so a placement error of a reticle 1 loaded onto the reticle stage 2 changes every time a reticle 1 is mounted on the reticle stage 2. A placement error of the reticle 1 is measured by a process to be described later (step S106). Next, the control unit in the exposure apparatus controls a wafer transport means (not shown) to load a wafer 7 as an exposure processing target onto the wafer stage 5 (step S102). The wafer 7 mounted on the wafer stage 5 has a position error (including an orientation error). Such an error generated upon wafer mounting is accounted for by, for example, a placement error of the wafer 7, a pattern deviation from a standard profile, the pattern thickness, or a pattern shift in its height direction.

After the reticle and the wafer are loaded onto the reticle stage 2 and the wafer stage 5, the exposure apparatus measures the position of the wafer stage 5 in the measurement area 12 (step S103). This measurement is executed under the control of the control unit. In the measurement process in step S103, the stage reference marks 8 are measured using the wafer alignment scope 4 provided in the measurement area 12, and the precise position of the wafer stage with reference to the wafer alignment scope 4 is calculated. As a result, a shift (position error) from the original position of the wafer stage is detected. The control unit in the exposure apparatus then holds a position error of the wafer stage 5 in a memory such as a RAM (Random Access Memory) as data A. The reticle loading in the process of step S101, the wafer loading in the process of step S102, and the measurement of a wafer stage position error in the process of step S103 need not always be executed in the order shown in FIG. 3. For example, the order of these processes may be changed or they may be executed in parallel where possible.

The control unit in the exposure apparatus measures the error, which is generated upon wafer mounting in step S102, using the wafer alignment scope 4. More specifically, the control unit measures the Z height of the wafer 7 and X and Y shifts of the pattern on the wafer to measure position errors of the wafer 7 and each exposure shot on the wafer 7 (step S104). The measured position errors of the wafer 7 and each shot are held in a memory such as a RAM as data B, as in data A.

The control unit in the exposure apparatus controls a wafer driving mechanism to drive the wafer stage 5 from the measurement area 12 to the exposure area 11 (step S105). By this driving, the laser interferometer 9 used in wafer stage position control is switched. In other words, the wafer stage 5 in the exposure area 11 sustains position errors attributed to, for example, X and Y shifts, the θ rotation, a Z shift, and the tilt due to the switching of the laser interferometer 9 used.

After the wafer stage is driven to the exposure area 11, the control unit in the exposure apparatus measures, for example, a position error of the wafer stage 5 generated upon switching the interferometer used (step S106). TTR measurement, for example, is used in this error measurement, as described above. More specifically, a relative error between a reticle deformation error and placement error and a wafer stage position error is measured by bringing a mark attached on the reticle 1 and a wafer stage reference mark attached on the wafer stage 5 into the field of the wafer alignment scope 4, and aligning these marks. At the same time, an error component generated as the aberration of the projection optical system 3 fluctuates due to exposure heat or factors associated with the apparatus internal atmosphere is measured. The control unit in the exposure apparatus holds, in a memory such as a RAM as data C, the wafer stage position error obtained in this process. Note that in the process of step S106, various types of position errors are measured by TTR measurement. In such a process, it is a common practice to measure all of, for example, a reticle deformation error and placement error and a wafer stage position error without exception. In contrast, not all these errors are measured in the process of step S106 in this embodiment. Details of the process in step S106 will be described later, and, for example, a reticle placement error and the like are measured only when reticle replacement takes place at the start of processing of a new lot.

Subsequently, the control unit in the exposure apparatus performs an arithmetic correction operation for position errors of the reticle, wafer, stages, and projection optical system based on data A, B, and C stored in, for example, a RAM by the above-mentioned process to calculate the precise positions of the exposure shots. Then, the control unit exposes each shot step by step while driving the reticle stage 2 and the wafer stage 5 by the step & scan scheme based on the calculation result and correcting the imaging characteristics of the projection optical system 3 as well (step S107).

After the series of shots is completed, the control unit in the exposure apparatus checks whether a reticle replacement process is necessary. A reticle replacement process is necessary in, for example, multiple exposure using a plurality of reticle patterns. Note that the multiple exposure means an exposure method which transfers a plurality of reticle patterns onto a wafer in the same exposure shot. If reticle replacement is necessary (YES in step S108), the reticle replacement process takes place (step S109). After that, the process returns to step S106 to calculate a relative error between the reticle and the wafer again. If no reticle to be processed on a single wafer is present (NO in step S108), the control unit in the exposure apparatus controls the wafer driving mechanism to drive the wafer stage 5 to the measurement area 12 (step S110). As a result, the wafer is unloaded outside the exposure apparatus by the wafer transport means (step S111).

The control unit in the exposure apparatus checks whether a wafer to be processed is present. If a wafer to be processed is present (YES in step S112), the process returns to step S102 again. If no wafer to be processed is present (NO in step S112), the sequence of an exposure process is ended.

In this manner, even when an error generated upon loading a wafer or a reticle onto the stage or an error generated upon switching the interferometer used has been detected, the execution of the above-mentioned series of the sequence of an exposure process allows precise alignment between the reticle and the wafer (wafer stage).

The detailed sequence of the process in step S106 of FIG. 3 will be explained herein. More specifically, details of a process of measuring, by TTR measurement, a wafer stage position error and the like generated upon switching the interferometer used will be explained.

As the process shown in FIG. 3 starts, the control unit in the exposure apparatus checks whether reticle replacement has taken place immediately before the current time. That is, the control unit checks whether the sequence of an exposure process immediately after reticle replacement is in progress at the current time. If reticle replacement has taken place immediately before the current time (YES in step S201), the control unit in the exposure apparatus starts a measurement process corresponding to a second procedure. In this measurement process procedure, first, TTR measurement is executed for a set of mark groups XU/YU (marks XUL, XUR, YUL, and YUR as shown in FIG. 7) attached on the reticle 1, and the stage reference marks 8 (step S202). Note that the shift amounts of the stage reference marks with respect to the reticle marks are indicated by δxul, δxur, δyul, and δyur.

Subsequently, the exposure apparatus executes TTR measurement for a set of mark groups XD/YD (marks XDL, XDR, YDL, and YDR as shown in FIG. 7) attached on the reticle 1, and the stage reference marks 8 (step S203). Note that the shift amounts of the stage reference marks with respect to the reticle marks are indicated by δxdl, δxdr, δydl, and δydr.

After this measurement is completed, the control unit in the exposure apparatus calculates a rotation error (reticle placement error) of the reticle 1 in the moving direction of the reticle stage 2 (step S204). The calculation of a rotation error uses the values of δxul, δxur, δxdl, and δxdr. A reticle rotation error θr is calculated by:

θr=(δxul+δxur−δxdl−δxdr)/(2×Mspan) (1)

where Mspan is the distance between the mark groups XU and XD on the reticle. The control unit in the exposure apparatus stores, in a memory such as a RAM, the reticle rotation error amount Or derived by this calculation.

Subsequently, the exposure apparatus calculates a reticle Y magnification error (a reticle deformation error in the Y direction) using the values of δyul, δyur, δydl, and δydr (step S205). A reticle Y magnification error βr is calculated by:

βr=(δyul+δyur−δydl−δydr)/(2×Mspan) (2)

The control unit in the exposure apparatus stores, in a memory such as a RAM, the magnification error βr derived by the calculation.

Finally, the exposure apparatus calculates a wafer stage position error using only the information obtained by the set of the mark groups XD/YD (step S206). From the difference between the shift amounts of the left and right marks in the mark group YD, a wafer stage rotation amount θw can be calculated by:

θw=(δydr+δydl)/Mspan (3)

From the average of the shift amounts of the mark groups XD and YD, wafer stage translation amounts Sx and Sy can be calculated by:

Sx=(δxdr+δxdl)/2

Sy=(δydr+δydl)/2 (4)

If it is determined in step S201 that reticle replacement has not taken place immediately before the current time (NO in step S201), the control unit in the exposure apparatus starts a measurement process corresponding to a first procedure. In this measurement process procedure, only marks in a set of mark groups XD/YD are measured (step S207). That is, marks in mark groups XU and YU required in measuring a reticle deformation error and placement error are not measured. After this measurement, the exposure apparatus advances the process to step S206, described above, to calculate wafer stage shift amounts θw, Sx, and Sy using equations (3) and (4). As for a reticle placement error and deformation amount θR and βR, the values which have already been calculated and stored in the memory such as a RAM are used.

In this manner, it is checked whether reticle replacement has taken place immediately before the current time. This obviates the need for a process of measuring the marks in the mark groups XU/YU on the reticle when reticle replacement has not taken place immediately before the current time, and therefore makes it possible to shorten the processing time.

Although this embodiment has been explained assuming that a total of eight reticle marks XUL, XUR, YUL, YUR, XDL, XDR, YDL, and YDR are used, the number and combinations of marks are not particularly limited to them. The method according to this embodiment is applicable as long as the number and combinations of marks meet the conditions required to independently measure a reticle placement error, the reticle deformation amount, and the wafer stage shift amount.

### Second Embodiment

The second embodiment will be explained next. In the above-described first embodiment, measurement corresponding to the second procedure (including measurement of, for example, a reticle placement error) is executed only when reticle replacement has taken place immediately before the current time. This is because a placement error of the reticle 1 occurs upon reticle replacement, and changes in only negligibly small amounts thereafter. A case in which this process is intermittently executed in a lot a plurality of times by measuring a reticle error in the lot under a predetermined condition as well will be explained in the second embodiment. This is to take account of the fact that the reticle itself gradually deforms albeit very small under the influence of exposure light applied on the reticle. A reticle deformation error and placement error are measured, for example, every time n wafers are processed. This operation is executed in accordance with a parameter (count n) input by the operator via an input unit (not shown) provided in an exposure apparatus. A parameter may be input so that the operator can issue an execution instruction of this measurement at an arbitrary timing.

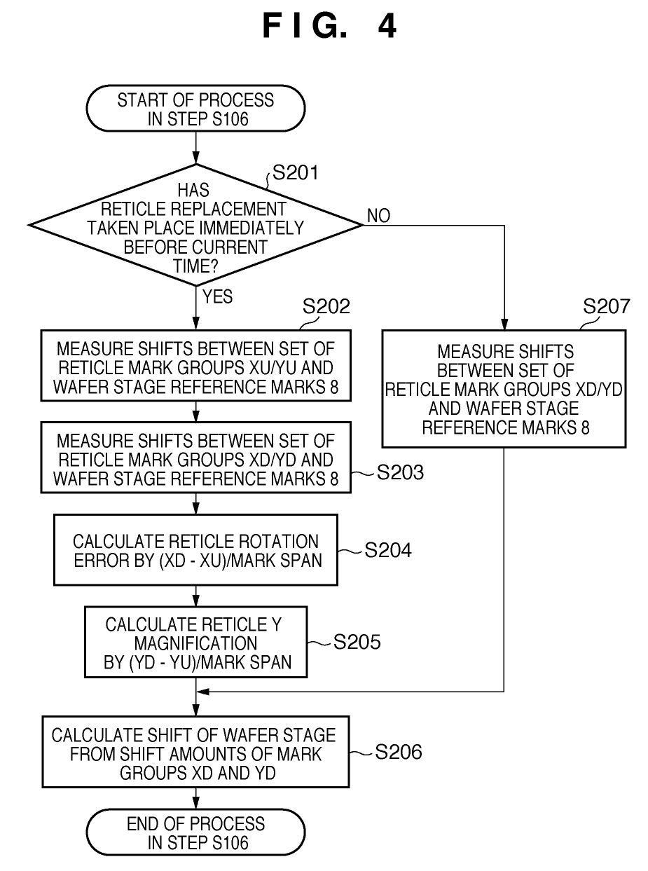

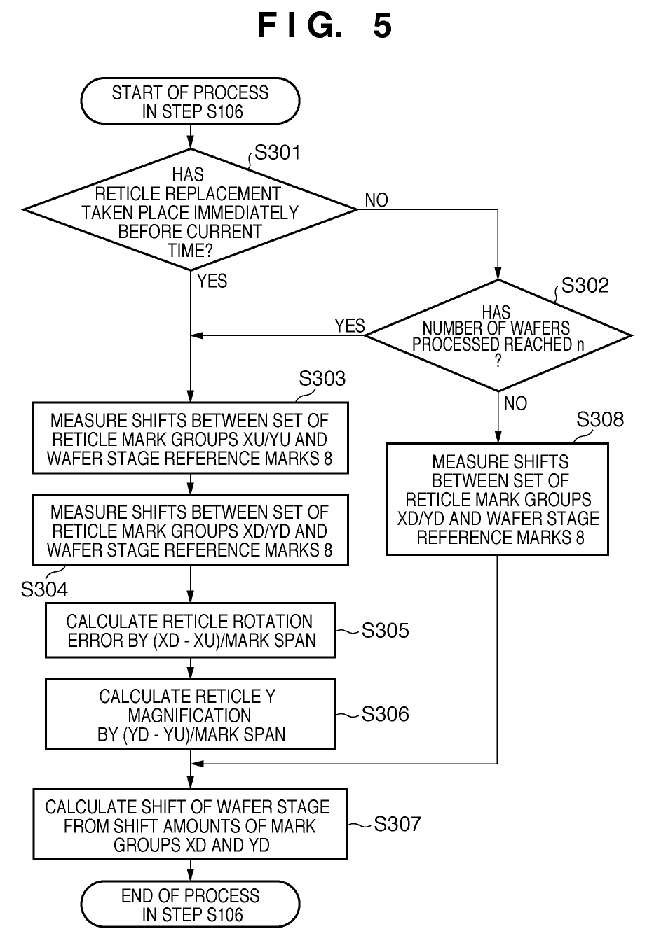

The sequence of an exposure process in an exposure apparatus according to the second embodiment will be explained below with reference to FIG. 5. The sequence of a process of measuring, by TTR measurement, a wafer stage position error and the like generated upon switching the interferometer used will be explained herein. Note that a parameter is assumed to be input in advance so that reticle deformation measurement is executed every n wafers. Also, processes other than those in steps S301 and S302 of FIG. 5 are the same as in the steps of FIG. 4 described in the first embodiment, and a description thereof will not be given herein.

As the process shown in FIG. 5 starts, a control unit in the exposure apparatus checks whether reticle replacement has taken place immediately before the current time. That is, the control unit checks whether the sequence of an exposure process immediately after reticle replacement is in progress at the current time. If reticle replacement has taken place immediately before the current time (YES in step S301), the control unit in the exposure apparatus starts a measurement process corresponding to the second procedure. More specifically, the control unit executes the same processes as in steps S202 to S206 of FIG. 4 in the first embodiment (steps S303 to S307).

If reticle replacement has not taken place immediately before the current time (NO in step S301), the control unit in the exposure apparatus checks whether the number of wafers processed is a predetermined number (n). That is, the control unit checks whether the current number of wafers processed has reached a designated number of wafers input as a parameter. If the number of wafers processed is the predetermined number (YES in step S302), the control unit in the exposure apparatus starts a measurement process corresponding to the second procedure. More specifically, the control unit executes the same processes as in steps S202 to S206 of FIG. 4 in the first embodiment (steps S303 to S307). Otherwise (NO in step S302), the control unit in the exposure apparatus starts a measurement process corresponding to the first procedure. More specifically, the control unit executes the same process as in step S207 of FIG. 4 in the first embodiment (step S308).

In this manner, the operator is allowed to designate a parameter to be input to the computer so that reticle deformation measurement can be executed intermittently (every n wafers). This allows precise measurement even when the reticle has deformed during lot processing.

Although a case in which the number of wafers is used as one example of the intermittent execution timings of reticle deformation measurement has been exemplified in the second embodiment, “the time elapsed from the (previous) execution of reticle deformation measurement” may be used. In this case, reticle deformation measurement is executed if the time elapsed from the (previous) execution of reticle deformation measurement has exceeded a predetermined time.

When the reticle has deformed due to a heat load, the reticle deformation amount is considered to change exponentially. By taking account of this fact, a schedule may be set such that reticle deformation measurement is frequently executed in the first half of lot processing, and is infrequently executed in the last half of (after the middle of) the lot processing, instead of setting the execution timings to be equal intervals. The scheduling need only designate a parameter representing unequal execution time intervals. For example, the scheduling is set to designate the timings of reticle deformation measurement in a lot to be unequal time intervals such as after the number of wafers processed has reached “1, 2, 5, 10, and 20”. In this case, the numbers of wafers processed, which represent the processing time intervals from the first half to the last half of lot processing, are designated to be relatively large. With this operation, abrupt reticle deformation at the beginning of lot processing can be suppressed, while the frequency of reticle deformation measurement can be lessened in the last half of the lot processing, in which deformation is stable. This makes it possible to improve the accuracy and raise the lot processing speed.

### Third Embodiment

The third embodiment will be explained next. In the above-described second embodiment, a case in which the operator inputs the execution timing of reticle deformation measurement as a parameter has been explained. In contrast, a case in which the execution timings of reticle deformation are determined automatically will be explained in the third embodiment.

In a general transmissive reticle, as the reticle transmittance decreases, the reticle deforms more conspicuously. In a general reflective reticle, as the reticle reflectance increases, the reticle deforms more conspicuously. In other words, the amount of reticle deformation can be predicted based on the amount of exposure light absorbed by the reticle, that is, the exposure-light absorptance. Hence, in the third embodiment, the execution timings of reticle deformation measurement are automatically determined in accordance with the reticle transmittance.

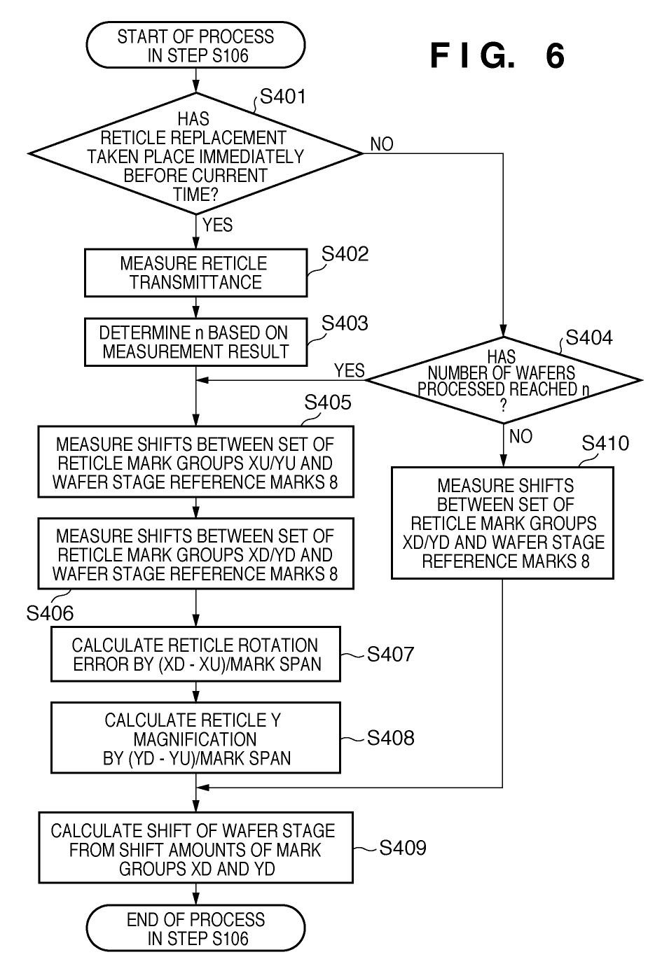

The sequence of an exposure process in an exposure apparatus according to the third embodiment will be explained below with reference to FIG. 6. The sequence of a process of measuring, by TTR measurement, a wafer stage position error and the like generated upon switching the interferometer used will be explained herein. Also, processes other than those in steps S401 to S404 of FIG. 6 are the same as in the steps of FIG. 4 described in the first embodiment, and a description thereof will not be given herein.

As the process shown in FIG. 6 starts, a control unit in the exposure apparatus checks whether reticle replacement has taken place immediately before the current time. If reticle replacement has taken place immediately before the current time (YES in step S401), the control unit in the exposure apparatus measures the reticle transmittance (step S402). Note that the reticle transmittance can be automatically measured by a known method as disclosed in, for example, Japanese Patent Laid-Open No. 63-132427, and a description thereof will not be given.

After the reticle transmittance is measured, the control unit in the exposure apparatus determines based on the measurement result the number (n) of wafers processed, at which reticle deformation measurement is executed (step S403). For example, the control unit automatically determines a parameter representing the execution time interval of reticle deformation measurement as “every 10 wafers” for a reticle transmittance of less than 3%, as “every five wafers” for a reticle transmittance of less than 30% to 60%, and as “every three wafers” for a reticle transmittance of 60% or more.

When the execution timings of reticle deformation measurement are thus determined, the control unit in the exposure apparatus starts a measurement process corresponding to the second procedure. More specifically, the control unit executes the same processes as in steps S202 to S206 of FIG. 4 in the first embodiment (steps S405 to S409).

If reticle replacement has not taken place immediately before the current time (NO in step S401), the control unit in the exposure apparatus checks whether the number of wafers processed is a predetermined number (n). That is, the control unit checks whether the current number of wafers processed is equal to the designated number of wafers, which is determined by the process in step S403. If the number of wafers processed is the predetermined number (YES in step S404), the control unit in the exposure apparatus starts a measurement process corresponding to the second procedure. More specifically, the control unit executes the same processes as in steps S202 to S206 of FIG. 4 in the first embodiment (steps S405 to S409). Otherwise (NO in step S404), the control unit in the exposure apparatus starts a measurement process corresponding to the first procedure. More specifically, the control unit executes the same process as in step S207 of FIG. 4 in the first embodiment (step S410).

With this operation, reticle deformation measurement is executed in accordance with the reticle used, improving the productivity. In addition, an effect of preventing operator's determination and operation mistakes can be obtained.

Although a case in which the number of wafers is used as one example of the intermittent execution timings of reticle deformation measurement has been exemplified in the third embodiment, “the time elapsed from the (previous) execution of reticle deformation measurement” may be used, as in the second embodiment. In this case, reticle deformation measurement is executed if the time elapsed from the (previous) execution of reticle deformation measurement has exceeded a predetermined time.

Also, the execution timings of reticle deformation measurement may be automatically determined from the amount of change in the actual measurement value of the reticle deformation amount. For example, it is only necessary to execute reticle deformation measurement for each wafer at the beginning of processing, and determine the next execution timing in accordance with the amount of change in the reticle deformation amount from the previous reticle deformation amount. In this case, the number of times of measurement in a lot is determined in accordance with a change in the amount of actual reticle deformation, making it possible to reduce wasteful measurement.

As has been described above, according to the first to third embodiments, a procedure for use in alignment measurement between a reticle and a wafer (wafer stage) is changed according to the circumstances involved. This makes it possible to suppress a decrease in throughput attributed to driving of a reticle stage, which accompanies measurement of a reticle deformation error and placement error and the like, while maintaining a given alignment accuracy of the relative positional relationship between, for example, the reticle and the wafer stage.

Although exemplary embodiments of the present invention have been explained above, the present invention is not limited to the embodiments which have been described above and are shown in the drawings, and can be practiced by appropriately modifying the embodiments without departing from the spirit and scope of the present invention.

Although the reticle stage is driven to bring, for example, a mark attached on the reticle and a mark attached on the wafer stage into the field of the alignment scope in the above-described first to third embodiments, the present invention is not limited to this. For example, the alignment scope may be driven instead of driving the reticle stage. That is, marks and the like may be aligned by driving at least one of the reticle stage and the alignment scope.

Devices (e.g., a semiconductor integrated circuit and a liquid crystal display device) are manufactured by an exposure step of exposing a substrate coated with a photosensitive agent using the exposure apparatus shown in FIGS. 1 and 2 described above, a development step of developing the exposed substrate, and other known steps.

According to the present invention, a procedure for use in alignment measurement between an original and a wafer (wafer stage) is changed according to the circumstances involved. This makes it possible to suppress a decrease in throughput attributed to driving of an original stage, which accompanies measurement of an original deformation error and placement error and the like, while maintaining a given alignment accuracy of the relative positional relationship between, for example, the original and the wafer stage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-152257 filed on Jun. 10, 2008, which is hereby incorporated by reference herein in its entirety.

What is claimed is:

1. An exposure apparatus which aligns an original held by an original stage with a substrate held by a substrate stage, and projects a pattern of the original onto the substrate to expose the substrate, the apparatus comprising:
a measurement unit configured to measure a positional relationship between a mark attached on the original and a mark attached on the substrate stage; and
a control unit configured to control the measurement unit to execute the measurement by bringing the mark attached on the original and the mark attached on the substrate into a field of the measurement scope,
wherein the control unit is configured to control the measurement unit to execute the measurement in accordance with a first procedure in the alignment when original replacement has not taken place in a sequence of an exposure process, and control the measurement unit to execute the measurement in accordance with a second procedure in the alignment immediately after original replacement has taken place in a sequence of an exposure process, thereby performing the alignment in accordance with the results obtained by the executed measurement, and
in the first procedure, the mark attached on the original is measured by the measurement unit a number of times smaller than a number of times of measurement in the second procedure.

2. The apparatus according to claim 1, wherein the control unit controls the measurement unit to execute the measurement in accordance with the second procedure in the alignment when the number of substrates processed has reached a predetermined value even if the original replacement has not taken place.

3. The apparatus according to claim 1, wherein the control unit controls the measurement unit to execute the measurement in accordance with the second procedure in the alignment when a time elapsed from the alignment executed in accordance with the second procedure has reached a predetermined value even if the original replacement has not taken place.

4. The apparatus according to claim 2, wherein the control unit determines the predetermined value based on a value input via an input device by an operator.

5. The apparatus according to claim 3, wherein the control unit determines the predetermined value based on a value input via an input device by an operator.

6. The apparatus according to claim 2, wherein the control unit determines the predetermined value in accordance with an exposure-light absorptance of the original.

7. The apparatus according to claim 3, wherein the control unit determines the predetermined value in accordance with an exposure-light absorptance of the original.

8. The apparatus according to claim 1, wherein
the control unit controls the measurement unit to execute the measurement a plurality of times in one lot, and
the control unit lessens a frequency of the measurement corresponding to the second procedure from the first half to the last half of processing of the lot.

9. The apparatus according to claim 1, wherein the control unit, in the first procedure, executes measurement of a shift amount of the substrate stage with respect to the original.

10. The apparatus according to claim 1, wherein the control unit, in the second procedure, executes measurement of a rotation amount of the original with respect to the substrate stage, a deformation amount of the original, and a shift amount of the substrate stage with respect to the original.

11. The apparatus according to claim 1, wherein the control unit controls a process for driving at least one of the original stage and the measurement unit in order to bring the mark attached on the original and the mark attached on the substrate stage into the field of the measurement unit.

12. A device manufacturing method comprising:
exposing a substrate by an exposure apparatus; and
developing the substrate,
wherein the exposure apparatus which aligns an original held by an original stage with a substrate held by a substrate stage, and projects a pattern of the original onto the substrate to expose the substrate, includes
a measurement unit configured to measure a positional relationship between a mark attached on the original and a mark attached on the substrate stage; and
a control unit configured to control the measurement unit to execute the measurement by bringing the mark attached on the original and the mark attached on the substrate into a field of the measurement scope,
wherein the control unit is configured to control the measurement unit to execute the measurement in accordance with a first procedure in the alignment when original replacement has not taken place in a sequence of an exposure process, and control the measurement unit to execute the measurement in accordance with a second procedure in the alignment immediately after original replacement has taken place in a sequence of an exposure process, thereby performing the alignment in accordance with the results obtained by the executed measurement, and
in the first procedure, the mark attached on the original is measured by the measurement unit a number of times smaller than a number of times of measurement in the second procedure.
